(19) United States
(12) Patent Application Publication
(10) Pub. No.: US 2025/0363788 A1
(43) Pub. Date: Nov. 27, 2025

(54) Semi-Generative Artificial Intelligence

(71) Applicant: The Boeing Company, Arlington, VA (US)

(72) Inventors: Amir Afrasiabi, Fircrest, WA (US); Sina Rafati, Austin, TX (US)

(21) Appl. No.: 18/673,841

(22) Filed: May 24, 2024

(51) Int. Cl. G06V 10/80; G06V 30/422

(52) U.S. Cl. CPC G06V 10/803; G06V 30/422; G06V 2201/10

(57) ABSTRACT

Semi-generative artificial intelligence modelling between domains is provided. The method comprises receiving a source image of an object in a first domain and diffusing the source image through a source diffusion model to generate a first Gaussian distribution in the first domain. Embeddings are generated from metadata which provides constraints for image reconstruction. The embeddings are fed into dual diffusion implicit bridges. The first Gaussian distribution is sampled and mapped, through the dual diffusion implicit bridges, from the first Gaussian distribution to a second Gaussian distribution in a second domain. The second Gaussian distribution is then reversed diffused through a target diffusion model to generate a target image of the object in the second domain in accordance with the metadata.

### BACKGROUND INFORMATION

### Technical Field

The present disclosure relates generally to artificial intelligence systems, and more specifically to controlling randomized noise in generative AI models.

### Background

Object detection systems implementing artificial intelligence are trained to accurately detect target objects using large realistic visual data sets, which have high accuracy, specificity, and diversity. High accuracy is achieved by reducing biases from human labelers. High specificity is achieved by capturing different images of the target object in various environmental conditions. High diversity is achieved by including various images of the target object from various view angles and perspectives. However, developing large realistic visual data sets with high accuracy, specificity, and diversity is a challenge, especially using conventional methods of manually taking pictures of the target objects using cameras, and having a human operator label each image with a ground truth target object class. These limitations have slowed the development and deployment of large scale object detection systems.

### SUMMARY

An illustrative embodiment provides a method for semi-generative artificial intelligence modelling between domains. The method comprises receiving a source image of an object in a first domain and diffusing the source image through a source diffusion model to generate a first Gaussian distribution in the first domain. Embeddings are generated from metadata which provides constraints for image reconstruction. The embeddings are fed into dual diffusion implicit bridges. The first Gaussian distribution is sampled and mapped, through the dual diffusion implicit bridges, from the first Gaussian distribution to a second Gaussian distribution in a second domain. The second Gaussian distribution is then reversed diffused through a target diffusion model to generate a target image of the object in the second domain in accordance with the metadata.

Another illustrative embodiment provides a system for semi-generative artificial intelligence modelling between domains. The system comprises a storage device that stores program instructions and one or more processors operably connected to the storage device and configured to execute the program instructions to cause the system to: receive a source image of an object in a first domain; diffuse the source image through a source diffusion model to generate a first Gaussian distribution in the first domain; generate embeddings from metadata, wherein the metadata provides constraints for image reconstruction; feed the embeddings into dual diffusion implicit bridges; sample from the first Gaussian distribution; map, through the dual diffusion implicit bridges, the sample from the first Gaussian distribution to a second Gaussian distribution in a second domain; and reverse diffuse the second Gaussian distribution through a target diffusion model to generate a target image of the object in the second domain in accordance with the metadata.

Another illustrative embodiment provides a computer program product for semi-generative artificial intelligence modelling between domains. The computer program product comprise a computer-readable storage medium having program instructions embodied thereon to perform the steps of: receiving a source image of an object in a first domain; diffusing the source image through a source diffusion model to generate a first Gaussian distribution in the first domain; generating embeddings from metadata, wherein the metadata provides constraints for image reconstruction; feeding the embeddings into dual diffusion implicit bridges; sampling from the first Gaussian distribution; mapping, through the dual diffusion implicit bridges, the sample from the first Gaussian distribution to a second Gaussian distribution in a second domain; and reverse diffusing the second Gaussian distribution through a target diffusion model to generate a target image of the object in the second domain in accordance with the metadata.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a semi-generative system in accordance with an illustrative embodiment;

FIG. 2 depicts a diagram illustrating a diffusion model with which the illustrative embodiment can be implemented;

FIG. 3 depicts a diagram illustrating an example of image translation between domains in accordance with an illustrative embodiment;

FIG. 4 depicts a diagram illustrating semi-generative AI image generation using metadata constraints in accordance with an illustrative embodiment;

FIG. 5 depicts an example of imaging decoding from a 3D CAD model to a photorealistic model in accordance with an illustrative embodiment;

FIG. 6 depicts a flowchart illustrating a process for semi-generative artificial intelligence modelling between domains in accordance with an illustrative embodiment; and

FIG. 7 is an illustration of a block diagram of a data processing system in accordance with an illustrative embodiment.

### DETAILED DESCRIPTION

The illustrative embodiments recognize and take into account that generative artificial intelligence (AI) models lack accuracy and validation layers to verify integrity of generated content.

The illustrative embodiments provide a method of semi-generative AI modeling in which adds an additional layer of accuracy and fidelity to generated contents from generative AI models. By utilizing meta data from Design, Production, and Inspection data in manufacturing and production environment the illustrative embodiments control output of the generative AI models through Dual-Fusion techniques.

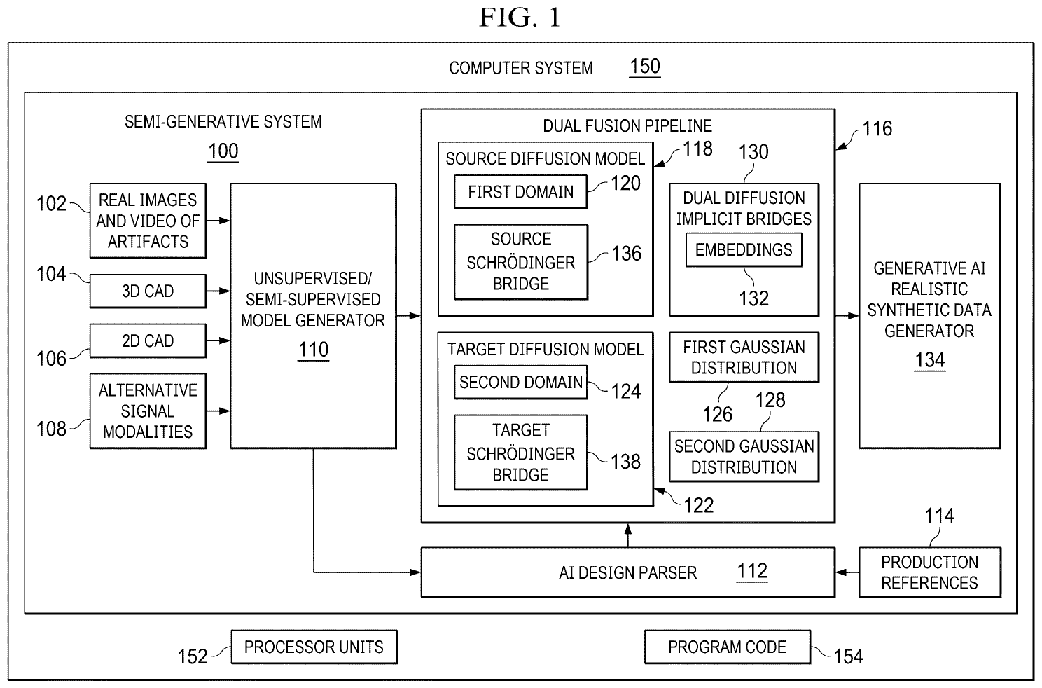

FIG. 1 is a block diagram of a semi-generative system depicted in accordance with an illustrative embodiment. Semi-generative system 100 utilizes data from a variety of sources including real images and video 102 of artifacts, three-dimensional (3D) computer assisted design (CAD) data 104, two-dimensional (2D) CAD drawings 106, and alternative signal modalities 108.

Real images and video 102 of artifacts act as ground truth data for real domain dataset generation. 3D CAD data 104 provides another domain for image data. 3D CAD data 104 can be derived from engineering Product Data Management (PDM) and is used for synthetic domain dataset generation.

2D CAD drawings 106 provide production and design engineering metadata (i.e., anything data that is not a 3D object). Alternative signal modalities 108 provide additional metadata such as textual data, audio data, or graph representation describing real images and video 102. The metadata provides constraints to ensure that AI generated images conform to desired characteristics. When converting image data from one domain to another, the constraints exert control over the output domain (e.g., a specific type of object viewed from a specific angle). Such constraints help ensure that the output image is as close as possible to an original input image in all respects.

The data and metadata from real images and video 102 of artifacts, three-dimensional (3D) computer assisted design (CAD) data 104, two-dimensional (2D) CAD drawings 106, and alternative signal modalities 108 are fed into unsupervised/semi-supervised model generator 110, which comprises an end-to-end object detection system that identifies objects using structured data and unstructured data. Images are cropped and converted to latent space and then clustered according to visual similarity. Clusters are then matched to features of a provided example and labeled.

The different modalities of data are then fed by unsupervised/semi-supervised model generator 110 into dual fusion pipeline 116.

AI design parser 112 reads and interprets information from production references 114 (e.g., engineering drawings) regarding limitations of the target object to be generated to match with real images and video 102 to provide additional constraints. AI design parser 112 is able to provide information that might be missing from the alternative signal modalities 108. AI design parser 112 can cross-reference text, geometry, engineering specifications, and mathematics against real images and video 102.

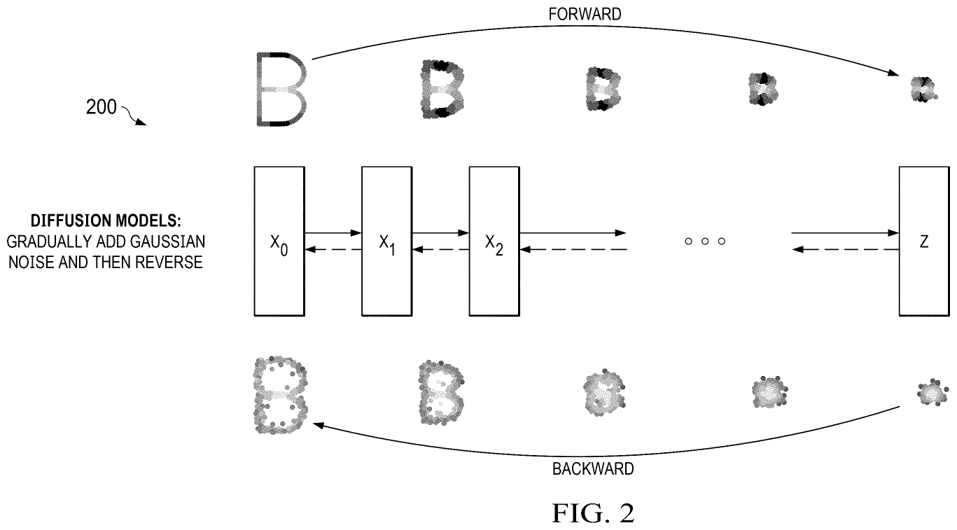

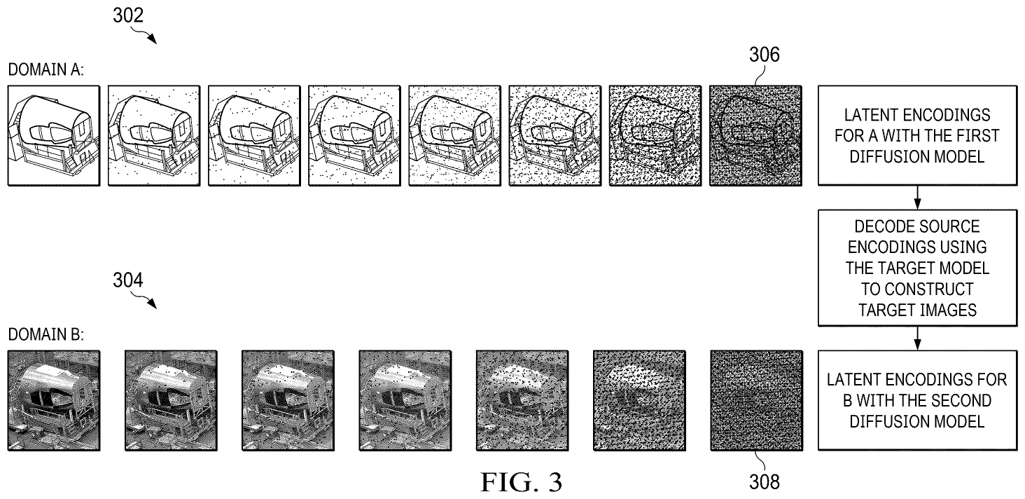

Dual fusion pipeline 116 comprises a source diffusion model 118 that is trained on a first domain 120 of data (e.g., 3D CAD). Source diffusion model 118 uses a source Schrödinger bridge 136 to generate a first Gaussian distribution 126 in the first domain 120 from image data. (See FIGS. 2 and 3). A diffusion Schrödinger bridge seeks to find a stochastic process that connects two probability distributions in the most probable way within given constraints.

Dual fusion pipeline 116 also comprises a target diffusion model 122 that is trained on a second domain 124 of data (e.g., real world). Target diffusion model 122 uses target Schrödinger bridge 138 for reverse diffusion to generate image data in the second domain 124 from a second Gaussian distribution 128.

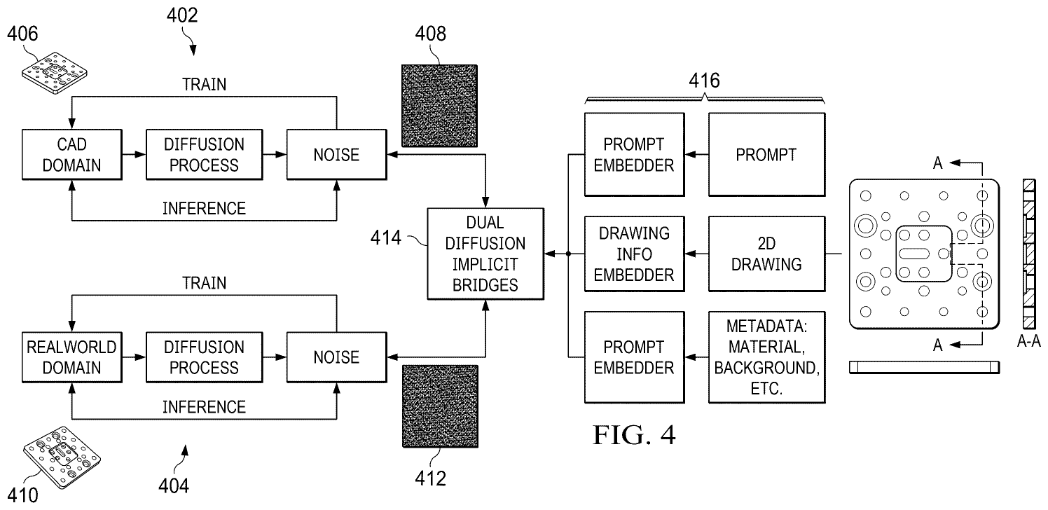

Dual diffusion implicit bridges 130 provide translation between first Gaussian distribution 126 and second Gaussian distribution 128 by mapping from the first domain 120 to the second domain 124. (See FIG. 4). Dual diffusion implicit bridges 130 are a back-to-back concatenation of source to latent space and from latent space to target Schrödinger bridge 138. Dual diffusion implicit bridges 130 can incorporate embeddings 132 generated from metadata provided by 2D CAD 106, alternative signal modalities 108, and AI design parser 112. The metadata represented by embeddings 132 provide constraints when translation between Gaussian distributions of different domains.

The dual fusion pipeline 116 has the advantage of images with superior FID (Fréchet Inception Distance) scores than other models. FID is a measure of the quality of images created by generative models. FID compares the distribution of generated images with the distribution of a set of real images (which function as ground truth). A lower FID score indicates greater similarity between generated and real images. Diffusion models can generate lower FID scores than other types of models such as Generative Adversarial Networks (GANs).

The output from the dual fusion pipeline 116 is fed into generative AI realistic synthetic data generator 136, which generates synthetic data for use by object detection models.

Semi-generative system 100 can be implemented in software, hardware, firmware, or a combination thereof. When software is used, the operations performed by semi-generative system 100 can be implemented in program code configured to run on hardware, such as a processor unit. When firmware is used, the operations performed by semi-generative system 100 can be implemented in program code and data and stored in persistent memory to run on a processor unit. When hardware is employed, the hardware can include circuits that operate to perform the operations in semi-generative system 100.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a mobile device such as a tablet computer, or some other suitable data processing system.

As depicted, computer system 150 includes a number of processor units 152 that are capable of executing program code 154 implementing processes in the illustrative examples. As used herein, a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different types of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 2 depicts a diagram illustrating a diffusion model with which the illustrative embodiment can be implemented. Diffusion model 200 is an example of first and second diffusion models 118, 122 in FIG. 1.

Diffusion model 200 is trained by progressively adding noise to an image in stages (i.e., X1, X2, etc.) and then reconstructing that image (reverse diffusion) from each stage. As the diffusion model 200 learns it is able to add more and more noise to the original image and successfully reconstruct that original image. In the final stage (Z) of training, the diffusion model 200 generates a random Gaussian distribution of noise from which it can reconstruct the original image.

For the diffusion process in generative modeling, the goal is to design algorithms which transform a given distribution Pₚᵣᵢₒᵣ into a given data distribution P_{data}:

$${dX}_{t} = - α {X}_{t} dt + \sqrt{2} {dB}_{t} , {X}_{0} ∼ {p}_{data} ,$$

Xₜ is interpreted as a noising process, perturbing the data distribution P_{data}. Pₚᵣᵢₒᵣ is the invariant distribution of the noising process. The process gradually adds noise, and if it is done in small steps for long enough time steps for T>0, Xₜ gets close to Pₚᵣᵢₒᵣ= [symbol] (0,1/α) with mean of 0 and standard deviation of

$$\frac{1}{α} .$$

For reverse diffusion, in principle the process can (approximately) sample from P_{data} by first sampling from Pₚᵣᵢₒᵣ and reversing the dynamics of Xₜ. This time-reversal operation leads to another diffusion process with explicit drift and diffusion matrix:

$${dY}_{t} = \{ α {Y}_{t} + 2 ∇ log {p}_{T - t} ( {Y}_{t} ) \} dt + \sqrt{2} {dB}_{t} , {Y}_{0} ∼ {p}_{prior}$$

where Pt is the density of Xₜ. The process is then required to follow Markov chain and discretization of the diffusion process.

The main limitation of generative modeling is its requirement of a large number of step sizes so that the initial forward dynamics is close to the distribution Pₚᵣᵢₒᵣ and small enough step sizes so that the neural network approximation holds.

Adding a Schrödinger Bridge allows significant reduction in the number of step sizes needed in order to define score-based generative modeling.

Assuming a reference diffusion Xₜ with distribution [symbol] describing the process adding noise to the data, the goal is to find π* such that π₀*=P_{data} and π_{T}*>=Pₚᵣᵢₒᵣ and minimize the Kullback-Leibler divergence between π*and [symbol] :

$${π}^{*} = arg min \{ KL ( π \vert ℙ ) , {π}_{0} = {p}_{data} , {π}_{N} = {p}_{prior} \}$$

FIG. 3 depicts a diagram illustrating an example of image translation between domains in accordance with an illustrative embodiment. This image-to-image translation relies on source diffusion model 302 and target diffusion model 304 that are trained independently on separate domains A and B, respectively. In the present example, domain A comprises CAD image data, and domain B comprises real world images. Training source diffusion model 302 and target diffusion model 304 independently on each domain allows identification of the Pₚᵣᵢₒᵣ for each domain.

Diffusion by source diffusion model 302 produces Gaussian distribution 306 which represents latent encodings for domain A. These latent encodings for source images with the source diffusion model 302 are then fed into target diffusion model 304 to construct target images. In this manner, the Gaussian distribution 306 of domain A is translated into Gaussian distribution 308 of domain B, which contains the latent encodings for domain B. Target diffusion model 304 then performs reverse diffusion on Gaussian distribution 308 to construct the target image. Therefore, in the present example a CAD image in domain A is transformed into a photorealistic image in domain B.

The processes of encoding source images and decoding to generate target images are defined via ordinary differential equations (ODEs). Therefore, the process is cycle consistent up to discretization errors of ODS solvers.

FIG. 4 depicts a diagram illustrating semi-generative AI image generation using metadata constraints in accordance with an illustrative embodiment. In this example, source diffusion model 402 generates Gaussian distribution 408 from source 3D CAD image 406 in the CAD domain. This first Gaussian distribution 408 is translated to a second Gaussian distribution 412 in the real world domain by dual diffusion implicit bridges 414

For the second half of the process (from latent space to the second domain) more meta data 416 is added to help the reverse diffusion to the real world domain. Examples of added metadata might include clustering of data, prompt embedding (e.g., black color), material (e.g., steel), 2D drawing information. The metadata 416 acts as constraints on the Schrödinger bridge of the target diffusion model 404, which generates a photorealistic image 410 in the real world domain from Gaussian distribution 412. The constraints provide control that ensures not only that the resultant target image is the same type of image/object as the source image but also is shown facing in the same direction, at the same angle, etc. Such precision and specificity is important for applications such as generating synthetic training data for object detection model training. Therefore, the metadata helps to ensure that the output is as close as possible to the original input.

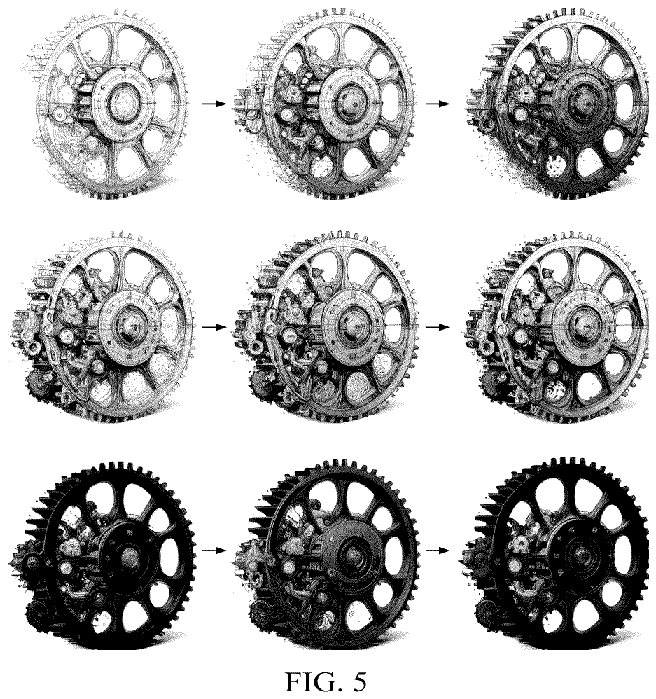

FIG. 5 depicts an example of imaging decoding from a 3D CAD model to a photorealistic model in accordance with an illustrative embodiment.

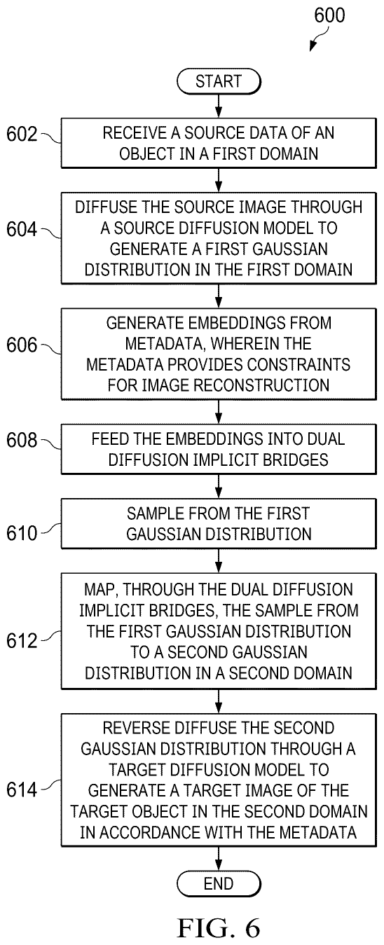

FIG. 6 depicts a flowchart illustrating a process for semi-generative artificial intelligence modelling between domains in accordance with an illustrative embodiment. Process 600 can be implemented in semi-generative system 100 in FIG. 1.

Process 600 begins by receiving a source image of an object in a first domain (operation 602). The first domain might comprise three-dimensional CAD (computer assisted drawing) image data, and the source image might comprise a CAD image. Process 600 diffuses the source image through a source diffusion model to generate a first Gaussian distribution in the first domain (operation 604).

Process 600 then generates embeddings from metadata, wherein the metadata provides constraints for image reconstruction (operation 606). The metadata comprises clustering of data, prompt embedding, segmentation mask, two-dimensional drawing information, text description of the target object, audio description of the target object, graph representation of the target object, material, or background. The metadata might also comprise information provided by an artificial intelligence design parser that cross-references text and specifications against images and video.

The embeddings are fed into dual diffusion implicit bridges (operation 608).

Process 600 samples from the first Gaussian distribution (operation 610) and maps, through the dual diffusion implicit bridges, the sample from the first Gaussian distribution to a second Gaussian distribution in a second domain (operation 612). The second domain might comprise real world image data.

Process 600 then reverse diffuses the second Gaussian distribution through a target diffusion model to generate a target image of the object in the second domain in accordance with the metadata (operation 612). In the case of real world image data domain, the target image generated from the reverse diffusion of the second Gaussian distribution comprises a photorealistic image.

Process 600 then ends.

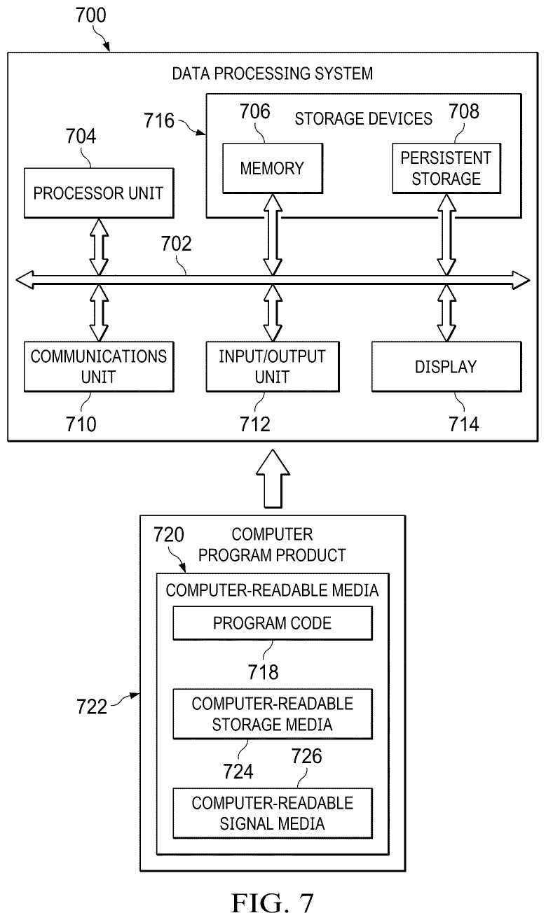

Turning now to FIG. 7, an illustration of a block diagram of a data processing system is depicted in accordance with an illustrative embodiment. Data processing system 700 may be used to implement computer system 150 in FIG. 1. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that may be loaded into memory 706. Processor unit 704 may be a number of processors, a multi-processor core, or some other type of processor, depending on the particular implementation. In an embodiment, processor unit 704 comprises one or more conventional general-purpose central processing units (CPUs). In an alternate embodiment, processor unit 704 comprises one or more graphical processing units (GPUS).

Memory 706 and persistent storage 708 are examples of storage devices 716. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 716 may also be referred to as computer-readable storage devices in these illustrative examples. Memory 706, in these examples, may be, for example, a random access memory or any other suitable volatile or non-volatile storage device. Persistent storage 708 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708. Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer-usable program code, or computer-readable program code that may be read and executed by a processor in processor unit 704. The program code in the different embodiments may be embodied on different physical or computer-readable storage media, such as memory 706 or persistent storage 708.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Computer readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 718 may be transferred to data processing system 700 using computer-readable signal media 726. Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code 718.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for semi-generative artificial intelligence modelling between domains, the method comprising:
using a number of processors to perform:
receiving a source image of an object in a first domain;
diffusing the source image through a source diffusion model to generate a first Gaussian distribution in the first domain;
generating embeddings from metadata, wherein the metadata provides constraints for image reconstruction;
feeding the embeddings into dual diffusion implicit bridges;
sampling from the first Gaussian distribution;
mapping, through the dual diffusion implicit bridges, the sample from the first Gaussian distribution to a second Gaussian distribution in a second domain; and
reverse diffusing the second Gaussian distribution through a target diffusion model to generate a target image of the object in the second domain in accordance with the metadata.

2. The method of claim 1, wherein the first domain comprises three-dimensional CAD (computer assisted drawing) image data.

3. The method of claim 1, wherein the second domain comprises real world image data.

4. The method of claim 3, wherein the target image comprises a photorealistic image.

5. The method of claim 1, wherein the metadata comprises at least one of:
clustering of data;
prompt embedding;
segmentation mask;
two-dimensional drawing information;
text description of the target object;
audio description of the target object;
graph representation of the target object;
material; or
background.

6. The method of claim 1, wherein the metadata comprises information provided by an artificial intelligence design parser that cross-references text and specifications against images and video.

7. The method of claim 1, wherein the source diffusion model and target diffusion model comprise Schrödinger bridges.

8. A system for semi-generative artificial intelligence modelling between domains, the system comprising:
a storage device that stores program instructions;
one or more processors operably connected to the storage device and configured to execute the program instructions to cause the system to:
receive a source image of an object in a first domain;
diffuse the source image through a source diffusion model to generate a first Gaussian distribution in the first domain;
generate embeddings from metadata, wherein the metadata provides constraints for image reconstruction;
feed the embeddings into dual diffusion implicit bridges;
sample from the first Gaussian distribution;
map, through the dual diffusion implicit bridges, the sample from the first Gaussian distribution to a second Gaussian distribution in a second domain; and
reverse diffuse the second Gaussian distribution through a target diffusion model to generate a target image of the object in the second domain in accordance with the metadata.

9. The system of claim 8, wherein the first domain comprises three-dimensional CAD (computer assisted drawing) image data.

10. The system of claim 8, wherein the second domain comprises real world image data.

11. The system of claim 10, wherein the target image comprises a photorealistic image.

12. The system of claim 8, wherein the metadata comprises at least one of:
clustering of data;
prompt embedding;
segmentation mask;
two-dimensional drawing information;
text description of the target object;
audio description of the target object;
graph representation of the target object;
material; or
background.

13. The system of claim 8, wherein the metadata comprises information provided by an artificial intelligence design parser that cross-references text and specifications against images and video.

14. The system of claim 8, wherein the source diffusion model and target diffusion model comprise Schrödinger bridges.

15. A computer program product for semi-generative artificial intelligence modelling between domains, the computer program product comprising:
a computer-readable storage medium having program instructions embodied thereon to perform the steps of:
receiving a source image of an object in a first domain;
diffusing the source image through a source diffusion model to generate a first Gaussian distribution in the first domain;
generating embeddings from metadata, wherein the metadata provides constraints for image reconstruction;
feeding the embeddings into dual diffusion implicit bridges;
sampling from the first Gaussian distribution;
mapping, through the dual diffusion implicit bridges, the sample from the first Gaussian distribution to a second Gaussian distribution in a second domain; and
reverse diffusing the second Gaussian distribution through a target diffusion model to generate a target image of the object in the second domain in accordance with the metadata.

16. The computer program product of claim 15, wherein the first domain comprises three-dimensional CAD (computer assisted drawing) image data.

17. The computer program product of claim 15, wherein the second domain comprises real world image data.

18. The computer program product of claim 15, wherein the metadata comprises at least one of:
clustering of data;
prompt embedding;
segmentation mask;
two-dimensional drawing information;
text description of the target object;
audio description of the target object;
graph representation of the target object;
material; or
background.

19. The computer program product of claim 15, wherein the metadata comprises information provided by an artificial intelligence design parser that cross-references text and specifications against images and video.

20. The computer program product of claim 15, wherein the source diffusion model and target diffusion model comprise Schrödinger bridges.
